(19) United States
(12) Patent Application Publication
(10) Pub. No.: US 2002/0163423 A1
(43) Pub. Date: Nov. 7, 2002

(54) RADIO COMMUNICATION APPARATUS CAPABLE OF DISPLAYING SUBSTITUTE MESSAGES

(76) Inventor: HISASHI KONDO, SHIZUOKA (JP)

Correspondence Address: SUGHRUE MION ZINN MACPEAK & SEAS, 2100 PENNSYLVANIA AVENUE NW, WASHINGTON, DC, 20037

(21) Appl. No.: 09/220,575

(22) Filed: Dec. 23, 1998

(30) Foreign Application Priority Data
Dec. 24, 1997 (JP) 355059/1997

(51) Int. Cl. H04Q 7/00

(52) U.S. Cl. 340/7.52

(57) ABSTRACT

In a radio communication apparatus, on the receipt of a radio signal via an antenna, an address number included in the radio signal is compared with an address number stored in the apparatus beforehand. If the two address numbers compare equal, a message processing section 4 converts a message signal following the address number to characters to be displayed and thereby produces message data. The message data are written to a message storage 7. Further, the message data are compared with an original message stored in a replacement message information storage 5 beforehand. If the message data includes the original message, then a portion of the message data corresponding to the original message is replaced with a substitute message. The replaced message data appear on a display 8. At the same time, an alert section 9 alerts the user of the apparatus to the call incoming.

### BACKGROUND OF THE INVENTION

1. Field of the Invention

The present invention relates to a radio communication apparatus for displaying received messages and more particularly to a radio communication apparatus capable of displaying a substitute message for an original received message.

2. Description of the Related Art

It is a common practice with a radio communication apparatus, e.g., a radio pager to store a received message while displaying it on a display. While the apparatus is in stand-by, the user of the apparatus may call the stored message and see it on the display. This kind of radio pager is taught in Japanese laid-open patent application heisei 4-273728 by way of example.

The problem with the above conventional radio pager is that even a telephone number, name and other information which may be included in a received message, but should be kept from persons other than the user of the pager, are displayed. This is undesirable from the secrecy standpoint.

### SUMMARY OF THE INVENTION

It is therefore an object of the present invention to provide more improved radio communication apparatus.

It is another object of the present invention to provide a radio communication apparatus insuring the secrecy of messages to be displayed against the third party.

In accordance with the present invention, a radio communication apparatus includes a first storage for storing a substitute message. A receiving section receives message data. A decision section determines whether or not the message data includes the substitute message. A replacing section replaces, when the message data includes the substitute message, the message data with another message data. A display displays a substitute message output from the replacing section.

Also, in accordance with the present invention, a radio communication apparatus includes a replacement message information storage for storing a substitute message. A radio section receives message data. A message processing section determines whether or not the message data include the substitute message and replaces, when the message data include the substitute message, the message data with another message data. A display displays a substituted message output from the message processing section.

Further, in accordance with the present invention, a method of processing a message received by a radio communication apparatus includes the steps of receiving message data, determining whether or not the message data includes a substitute message stored beforehand, replacing, when the message data includes the substitute message, the message data with another message data to thereby output a substituted message, and displaying the substituted message.

### BRIEF DESCRIPTION OF THE DRAWINGS

These and other objects, features and advantages of the present invention will become more fully apparent from the following detailed description taken in conjunction with the accompanying drawings in which:

FIG. 1 is a block diagram schematically showing a radio communication apparatus embodying the present invention;

FIG. 2 is a flowchart demonstrating a preferred operation of the illustrative embodiment;

FIG. 3 shows a preferred message conversion table stored in a message conversion table storage included in the illustrative embodiment;

FIG. 4 shows a preferred appearance of the apparatus shown in FIG. 1;

FIG. 5 is a table listing preferred characters stored in a character font storage also included in the illustrative embodiment;

FIG. 6 is a flowchart showing a preferred operation of a message processing section also included in the illustrative embodiment;

FIG. 7 shows a preferred configuration of a replacement message information storage also included in the illustrative embodiment;

FIGS. 8a-8d show preferred received messages appearing on a display also included in the illustrative embodiment;

FIG. 9 shows another preferred operation of the illustrative embodiment for allowing the user of the apparatus to decide whether or not to replace an original message with a substitute message;

FIGS. 10a-10e show preferred pictures appearing on the display during the procedure shown in FIG. 9;

FIG. 11 shows another preferred condition of the replacement message information storage associated with the procedure of FIG. 1;

FIG. 12 is a flowchart demonstrating a preferred procedure for allowing the user to set an original message and a substitute message;

FIG. 13a-13h shows preferred pictures appearing during the procedure of FIG. 12;

FIG. 14 is a flowchart showing another preferred procedure for the setting of an original message and a substitute message;

FIGS. 15a-15i show preferred pictures appearing during the procedure of FIG. 14;

FIG. 16 is a flowchart showing a message correction procedure also available with the illustrative embodiment;

FIGS. 17a-17d show preferred pictures appearing during the procedure of FIG. 16;

FIG. 18 is a flowchart showing a procedure for allowing the user to select a substitute message out of stored message data and then correct it;

FIGS. 19a-19d shows preferred pictures appearing during the procedure of FIG. 18;

FIG. 20 is a flowchart showing a preferred procedure for allowing the user to select either one of a first and a second method available with the present invention;

FIG. 21 is a flowchart showing a preferred procedure for allowing the user to decide whether or not to replace message data stored in a message storage also included in the illustrative embodiment; and

FIGS. 22a-22e shows preferred pictures appearing during the procedure of FIG. 21.

### DESCRIPTION OF THE PREFERRED EMBODIMENT

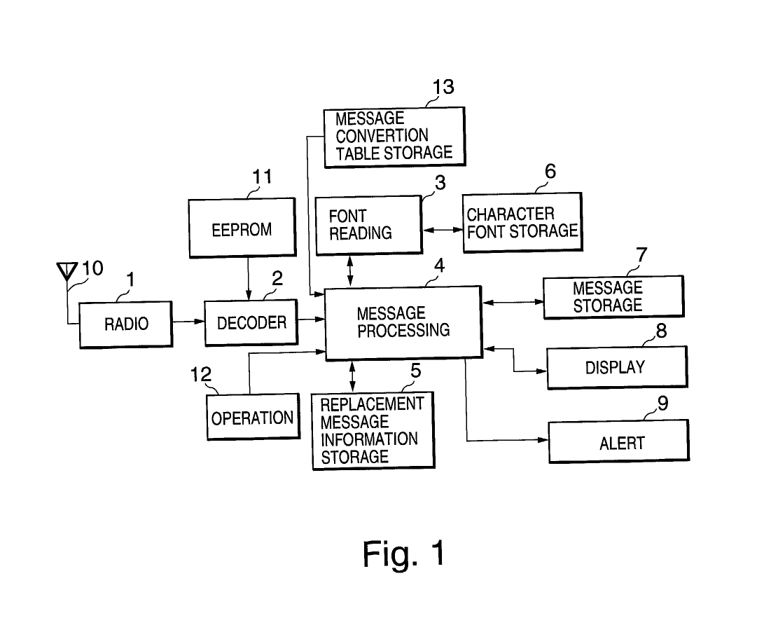

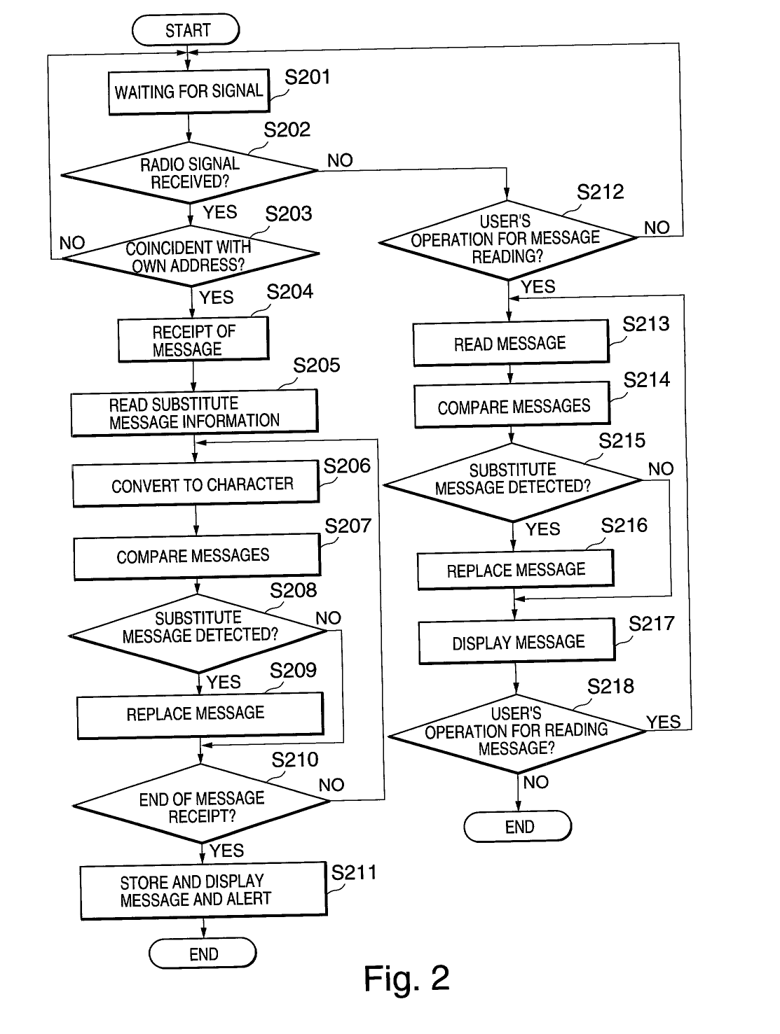

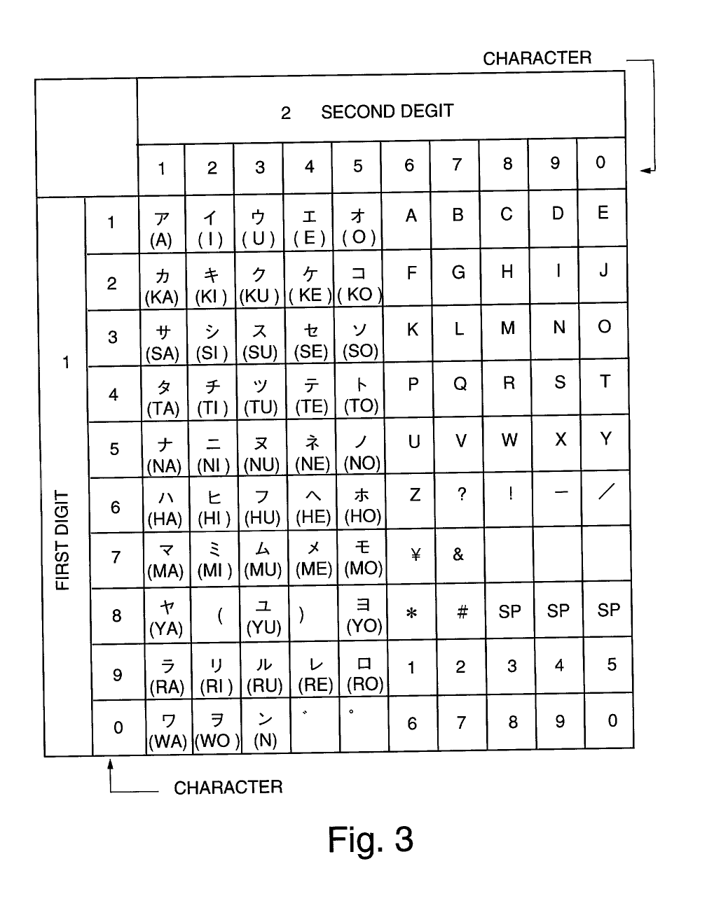

Referring to FIGS. 1 and 2, a preferred operation of a radio communication apparatus, e.g., a radio pager embodying the present invention will be described. As shown in FIG. 2, assume that when the pager is in its stand-by (step S201), it receives a paging signal from a base station, not shown, via an antenna 10 (YES, step S202). Then, a radio section 1 demodulates and amplifies the paging signal to thereby output a wave-shaped digital signal. A decoder 2 compares an address number included in the digital signal and an address number stored in an EEPROM (Electrically Erasable Programmable Read Only Memory) beforehand. If the two address numbers do not compare equal (NO, step S203), then the operation returns to the step S201. If the two address numbers compare equal (YES, step S203), then a message signal following the address number is fed from the decoder 2 to a message processing 4 (step S204). On receiving the message signal, the message processing 4 reads replacement message information out of a replacement message information storage 5 (step S205). At the same time, the message signal is transformed to display characters constituting message data on the basis of a message conversion table shown in FIG. 3 and stored in a message conversion table storage 13 (step S206). The message data are written to a message storage 7. Further, the message data are compared with an original message read for a replacement message information storage 5 (step S207).

If the answer of the step S207 is YES, then a portion of the message data corresponding to or identical with the original message is replaced with a substitute message stored in the replacement message information storage 5 beforehand (step S209). The steps S206-S209 are repeated until the end of the receipt of the message signal (step S210). When the message is replaced, the replaced message is displayed on the display 8 at the end of the receipt of the message signal. At the same time, an alert 9 alerts the user of the apparatus to the call incoming (step S211). If the answer of the step S208 is NO, meaning that the message data do not include the original message, then the message data are not replaced, but simply displayed on the display 8 (step S211); the alert 9 alerts the user to the incoming call. The alert 9 should preferably be implemented by at least one of a speaker, an LED (Light Emitting Diode), and a vibrator.

On the other hand, assume that the user operates the apparatus to read the stored message (YES, step S212) while a radio signal is not received (NO, step S202). Then, the message processing 4 reads one message data out of the message storage 7 in response to the operation of an operation 12 (step S213). The message data read are compared with the original message stored in a replacement message information storage (step S214). If the message data include the original message (YES, step S215), then the portion of the message data identical with the original message is replaced with a substitute message (step S216). The replaced message is displayed on the display 8 (step S217). If the answer of the step S215 is NO, then the message data are directly displayed on the display 8 without being replaced (step S21). When the user watching the display data on the display 8 performs an operation for reading the next message data (YES, step S218), the next message data stored in the message storage 7 are read out (step S213). Thereafter, the steps 213-217 are repeated.

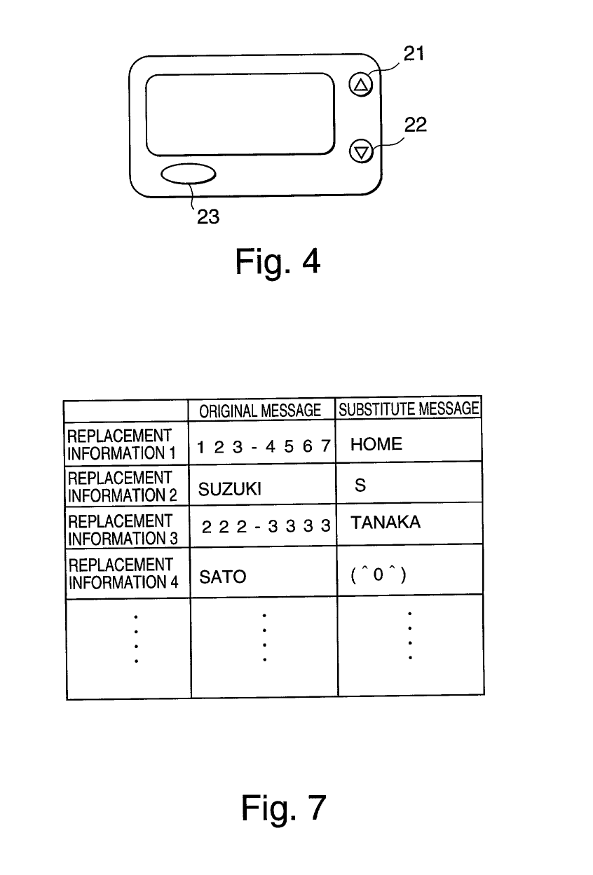

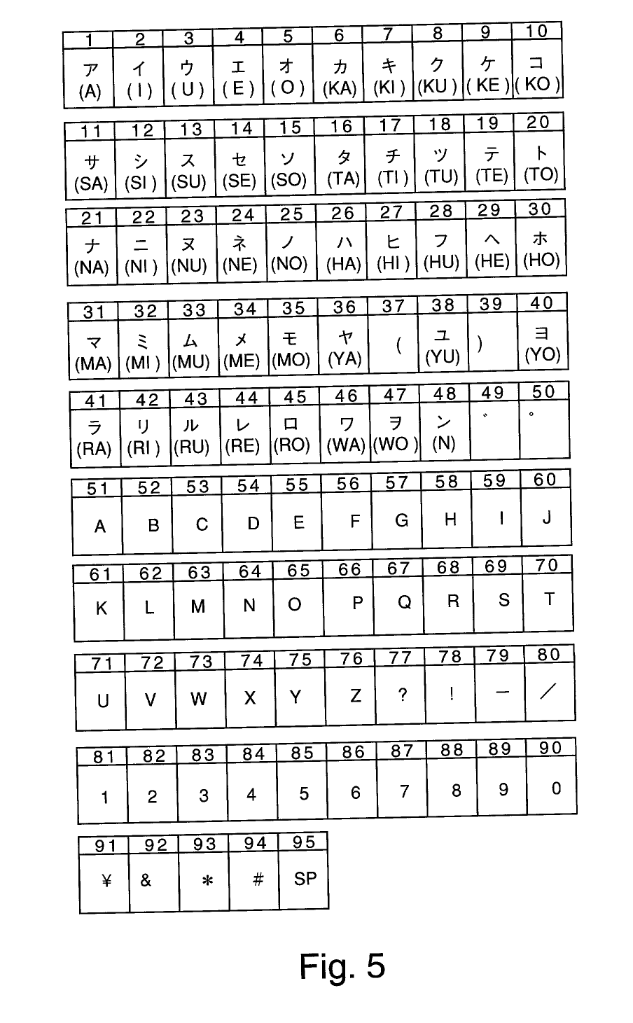

FIG. 4 shows a preferred appearance of the radio pager of FIG. 1. As shown, scroll buttons 21 and 22 and a set button 23 are arranged on the operation 12 shown in FIG. 1. The scroll buttons 21 and 22 are selectively used to scroll received messages, original messages, substitute messages or specific characters shown in FIG. 5, as needed. The characters of FIG. 5 are stored in a character font storage 6 shown in FIG. 1 beforehand and are sequentially displayed, the leading character “ [symbol] (A)” being first. The set button 23 is used to select and enter a desired message or a desired character.

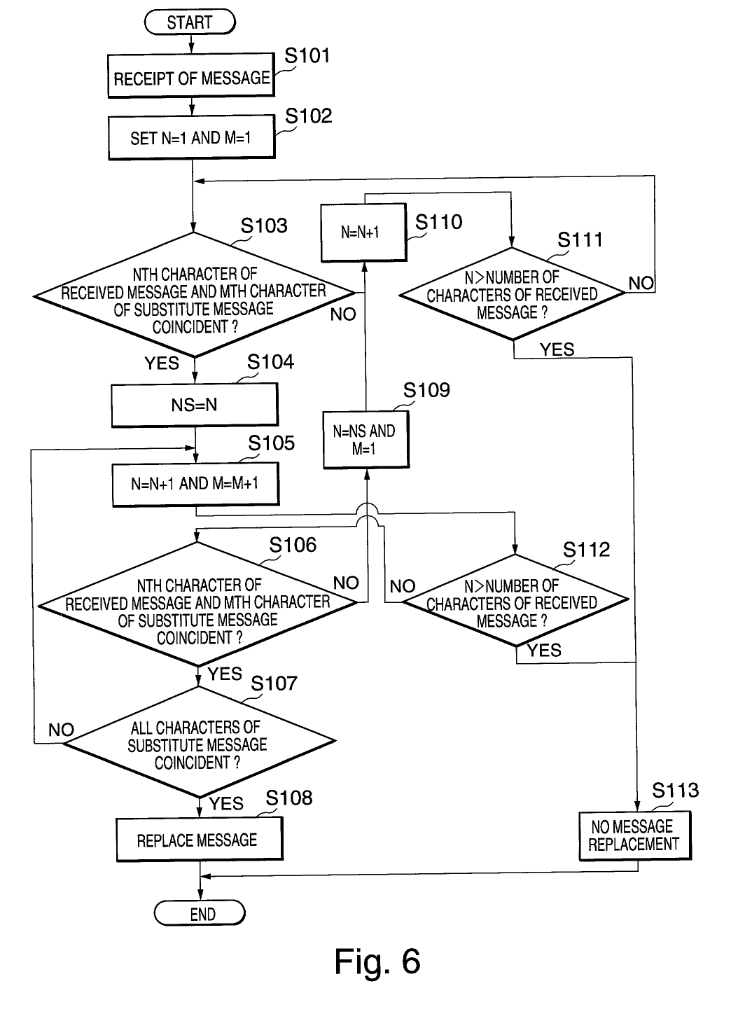

A preferred procedure in which the message processing 4, FIG. 1, compares a received message and a original message will be described with reference to FIG. 6. As shown, when the radio section 1 receives a message (step S101), N representative of the position of the character of the message to be compared is set to the initial value “1” (step S102). Also, M representative of the position of the character of an original message is set to the initial value “1” (step S102). Then, whether or not the Nth character and Mth character are identical is determined (step S103). If the answer of the step S103 is NO, then N is incremented by 1 (one) in order to compare the Mth character of the original message with the next character of the received message (step S110). At this instant, whether or not the incremented N is greater than the number of characters constituting the received message is determined (step S111). If the answer of the step S111 is YES, then the received message is not replaced (step S113).

If the answer of the step S103 is YES, meaning that the Nth character of the received message and the Mth character of the original message are identical, then NS representative of the position of the identical character of the received message is set to N (step S104). Thereafter, to compare the next character of the received message and the next character of the original message, N and M are incremented by 1 each (step S105). Again, whether or not the incremented N is greater than the number of characters constituting the received message is determined (step S112). If the answer of the step S112 is YES, then the received message is not replaced (step S113).

If the answer of the step S112 is NO, meaning that the incremented N is short of the number of characters of the received message, then the Nth character and Mth character of the received message and original message, respectively, are identical is determined (step S106). If the answer of the step S106 is NO, then N=NS is set in order to return N to one of the characters of the received message determined to be identical with the original message (step S109). At the same time, the M is restored to “1” for returning the character of the original message to the first character (step S109). Subsequently, N is incremented by 1 (step 110) in order to compare the character of the received message next to the character identical with the first character of the original message and the first character of the original message.

Assume that the Nth character of the received message and the Mth character of the original message are identical (YES, step S106). Then, whether or not all the characters of the original message are identical with the received message, i.e., M is equal to the number of characters of the original message is determined (step S107). If the answer of the step S107 is NO, then, the steps 105-107 are repeated. If the answer of the step S107 is YES, then the identical part of the received message is replaced with a substitute message stored beforehand in correspondence to the original message (step S108).

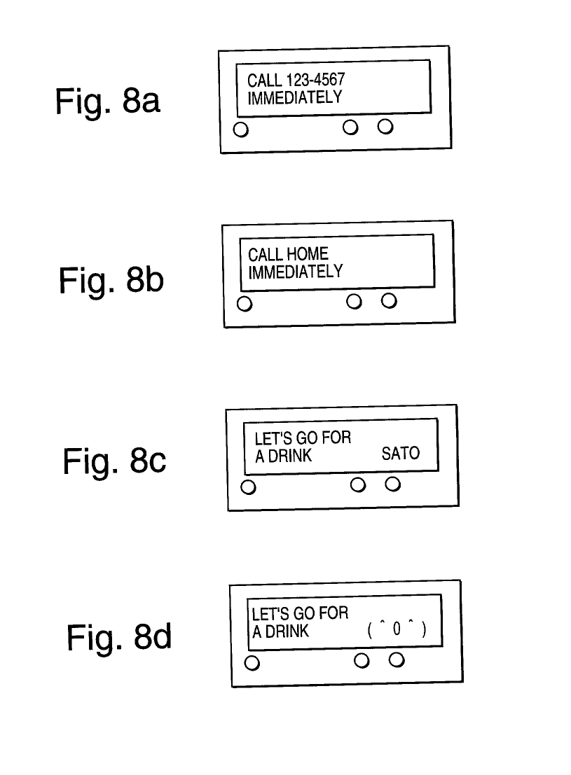

FIG. 7 shows a preferred configuration of the replacement message information storage 5. As shown, the storage 5 stores an original message, e.g., “123-4567” and a substitute message, e.g., “home” as a pair. Therefore, message data including “123-4567” are displayed with the original message “123-4567” being replaced with the substitute message “home”. More specifically, assume that the pager receives a message “Call 123-4567 immediately.” Then, the conventional radio pager faithfully displays the received message, as shown in FIG. 8a. By contract, as shown in FIG. 8b, the illustrative embodiment substitutes “home” for “123-4567”. Likewise, assume a received message “Let's go for a drink. Sato” shown in FIG. 8c. Then, while the conventional pager also faithfully displays such a message, as shown in FIG. 8c, the illustrative embodiment substitutes “0” for “Sato”, as shown in FIG. 8d.

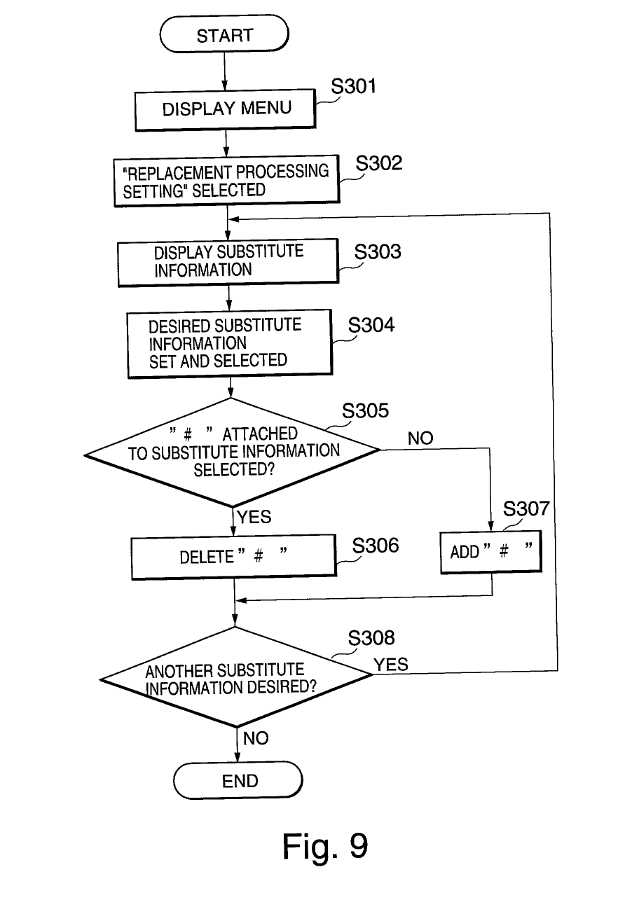

In the above procedure, when a received message includes an original message, the part of the received message corresponding to the original message is necessarily replaced with a corresponding substitute message. Alternatively, the user of the pager may decide whether or not to substitute substitute message information for original message information stored in the storage 5, FIG. 1, as will be described with reference to FIG. 9.

As shown in FIG. 9, assume that while the pager is in its stand-by, the user presses the set button 23 for a preselected period of time, e.g., 2 seconds or more. Then, a menu picture shown in FIG. 10a is displayed (step S301). When the user selects “Replacement Processing Setting” with the scroll button 21 or 22 on the menu picture (step S302), the next menu picture shown in FIG. 10b is displayed. Subsequently, when the user presses the set button 23, original messages and substitute messages are displayed in pairs, as shown in FIG. 10c (step S303). In FIG. 10c, the symbol “#” preceding any original message shows that the message data has been replaced with corresponding substitute information. That is, message data without the symbol “#” are not replaced with substitute information. The user watching the picture of FIG. 10c presses the scroll button 21 or 22 in order to select desired substitute information and then presses the set button 23 (step S304). Then, whether or not the symbol “#” is attached to the entered substitute information is determined (step S305). If the answer of the step S305 is YES, then the symbol “#” is deleted in order to prevent the message data from being replaced with the substitute information (step S306). If the answer of the step S305 is NO, then the symbol “#” is attached in order to replace the message data with the substitute information (step S307). After such replacement, whether or not any other substitute information to be set is present is determined (step S308). If the user desires to repeat the above replacement (YES, step S308), then the user selects another substitute information on the scroll button 21 or 22. This is followed by the steps S303-S307. FIG. 10d shows a preferred picture showing that the user has selected and entered substitute information corresponding to the original message “123-4567”. FIG. 10e shows another preferred picture showing that the user has selected and entered substitute information corresponding to an original message “Suzuki”.

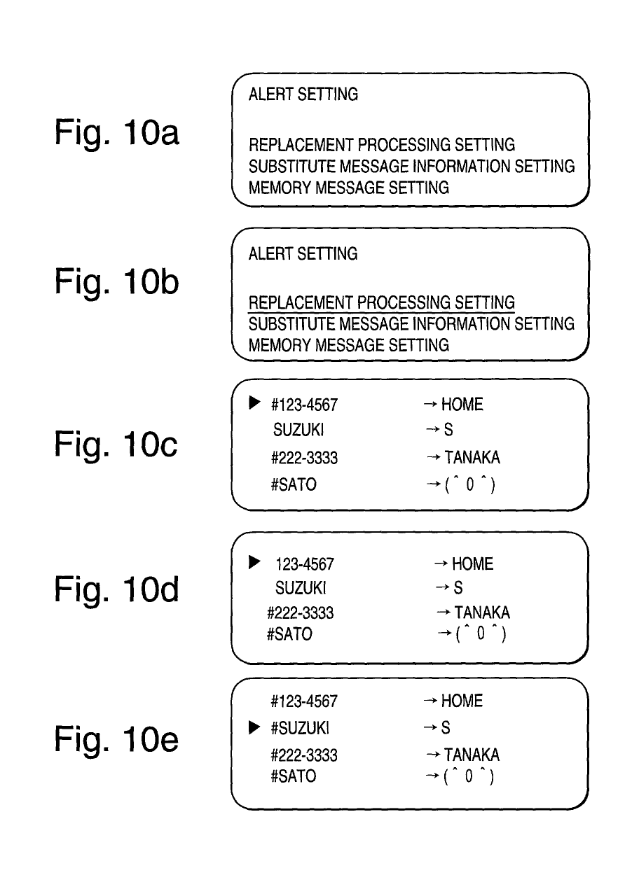

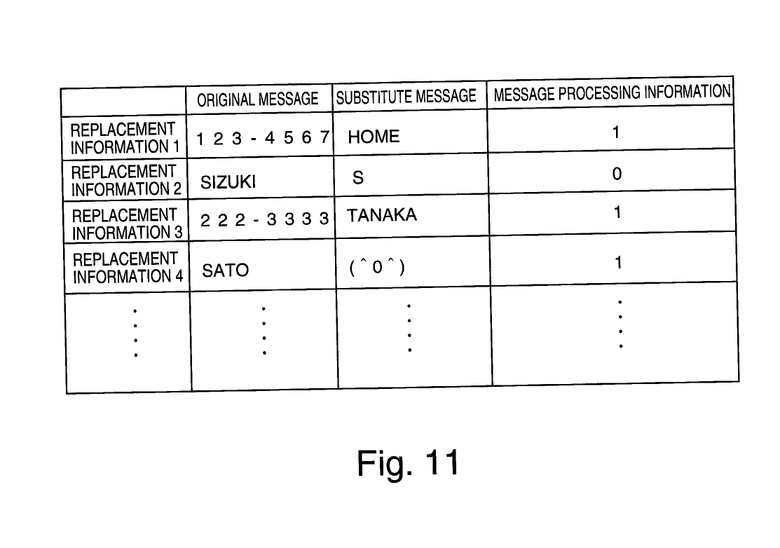

FIG. 11 shows a preferred condition of the storage 5 relating to the procedure described with reference to FIGS. 9 and 10a-10e. As shown, the storage 5 stores message processing information in addition to the messages shown in FIG. 7. The message processing information is a(logical) ONE when the replacement of message data will be executed or a (logical) ZERO when it will not be executed. Therefore, even when the received message data or the message data stored in the message storage 7 includes an original message with ZERO message processing information, e.g., “Suzuki”, “Suzuki” is not replaced with “S”.

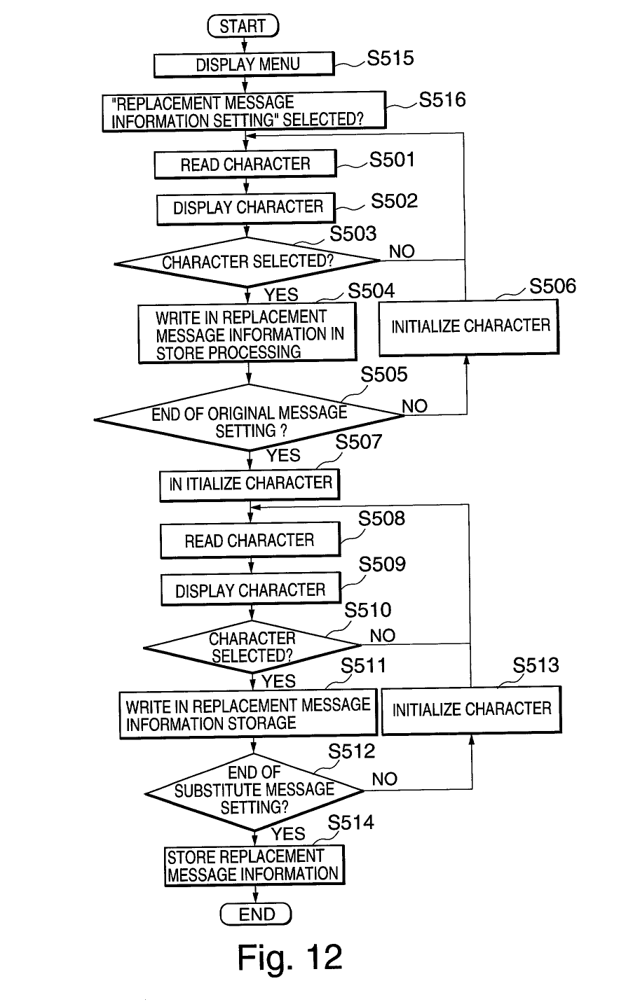

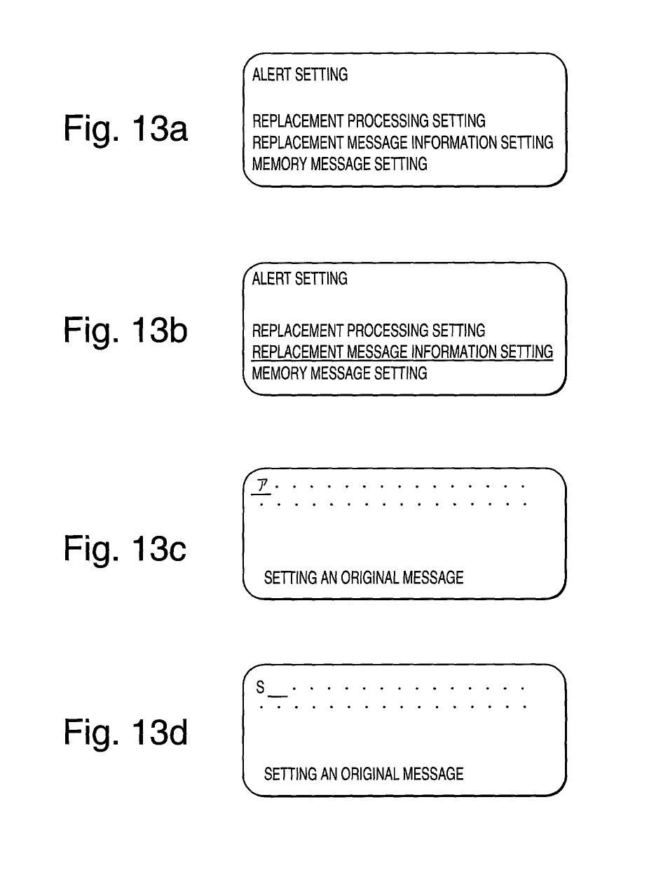

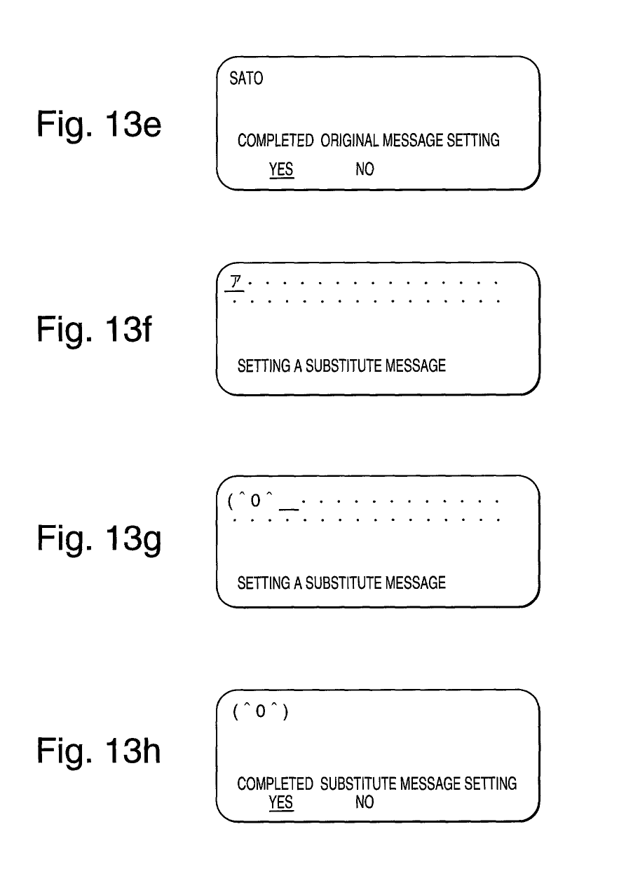

FIG. 12 demonstrates a preferred procedure allowing the user to set a desired original message and a desired substitute message. As shown, when the user presses the set button 23 for a preselected period of time, e.g., 2 seconds or more in the stand-by of the pager, a menu picture shown in FIG. 13a is displayed. When the user selects “Substitute Message Information Setting” on the scroll button 21 or 22 (step S516), a picture shown in FIG. 13b is substituted for the picture of FIG. 13a. When the user watching the picture of FIG. 13b presses the set button 23, a picture shown in FIG. 13c for allowing the user to set an original message is displayed. Every time the user presses the scroll button 21 or 22, characters are sequentially read, the character “ [symbol] (A)” being first (step S501). The characters sequentially appear on the display 8 (step S502). The user repeatedly presses the scroll button 21 or 22 until a desired character appears on the display 8. When the user finds a desired character on the display 8 and then presses the set button 23 (YES, step S503; FIG. 13d), the character selected is written to a replacement message information storage 5 (step S504). As shown in FIG. 13e, the user entered all the desired characters by use of the set button 23 presses the scroll button 21 or 22 to select “YES” indicative of the end of “Original Message Setting” and then presses the set button 23. In response, the program ends the setting of an original message (YES, step S505). If the answer of the step S505 is NO, the character is initialized (step S506), i.e., restored to “ [symbol] (A)” (step S501).

If the answer of the step S505 is YES, meaning that the setting of the original message has ended, then the operation begins the setting of a substitute message, as follows. First, the character is restored to the initial value (S507), and then consecutive characters are sequentially read, the character “ [symbol] (A)” being first, (step S508). The character read appears on the display 8, as shown in FIG. 13f (step S509). The user repeatedly presses the scroll button 21 or 22 until a desired character appears on the display 8. As shown in FIG. 3g, assume that the user found a desired character on the display 8 presses the set button 23 (YES, step S510). Then, the character selected is written to the replacement message information storage 5 (step S511). As shown in FIG. 13h, the user entered all the desired characters presses the scroll button 21 or 22 to select “YES” indicative of the end of setting of a substitute message, and then presses the set button 23. In response, the program ends the setting of a substitue message (YES, step S512). If the answer of the step S512 is NO, then the character is initialized (step S513), and the characters are again sequentially read, the character “ [symbol] (A)” being first, (step S508). When the setting of a substitute message ends (YES, step S512), the original message and substitute message are written to the replacement message information storage 5 in a pair (step S514). This is the end of the setting of replacing message information.

It is to be noted that the original message and substitute message may be set by use of message data stored in the message storage 7 in place of the characters stored in the character font storage 6.

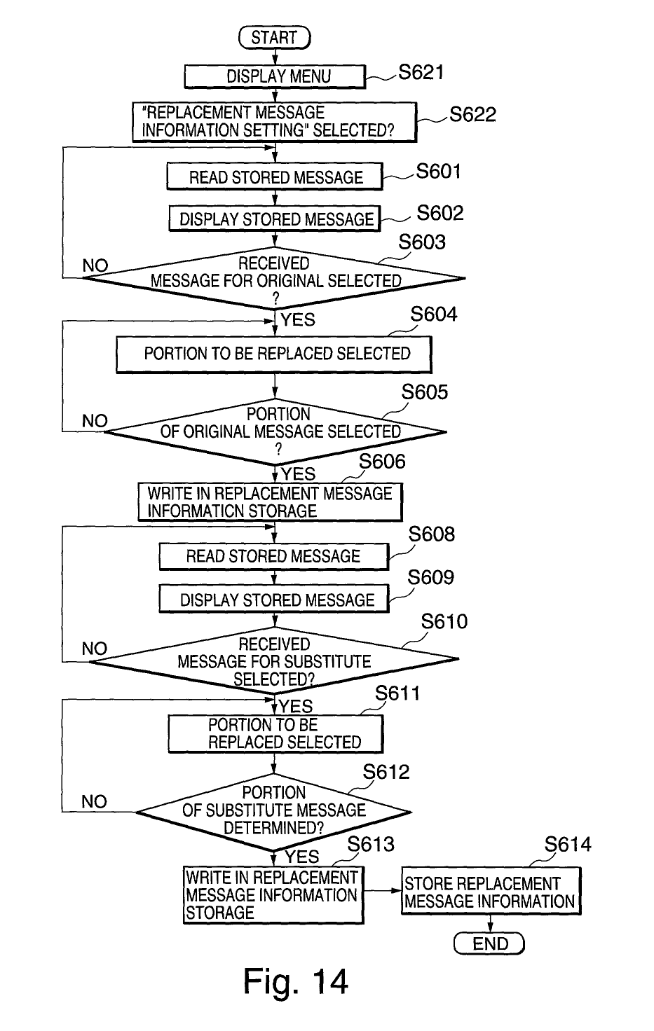

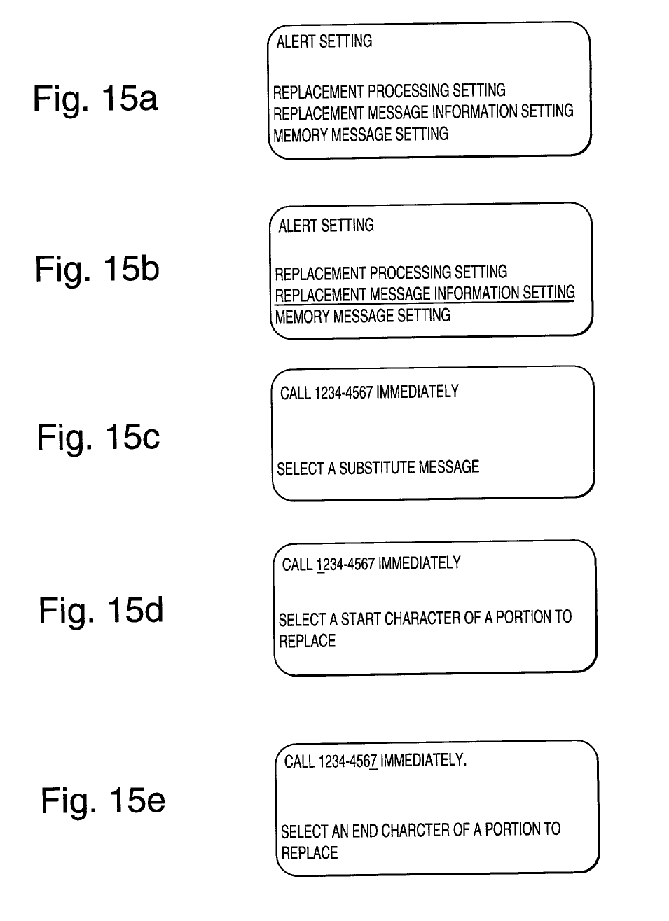

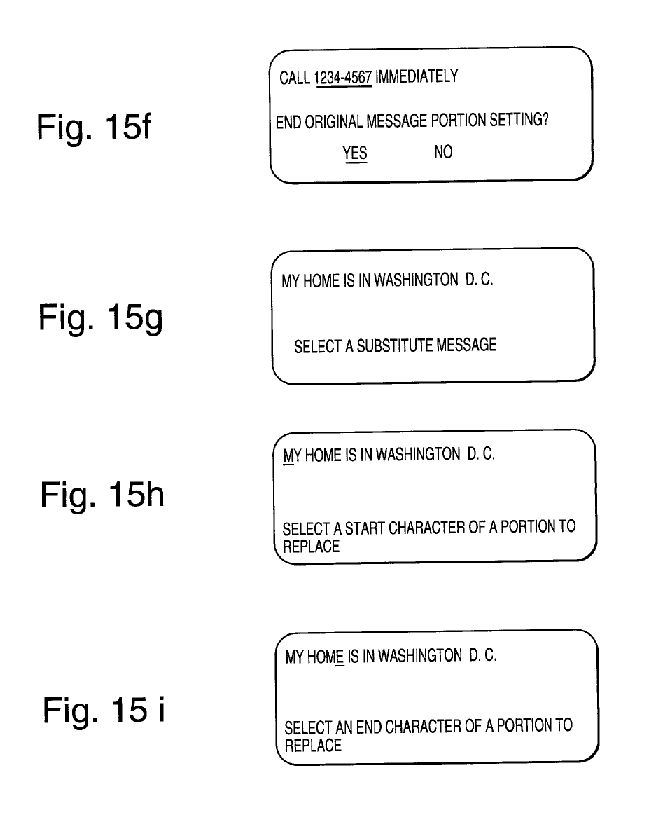

Reference will be made to FIG. 14 for describing another preferred procedure for setting an original message and a substitute message corresponding thereto. As shown, assume that the user presses the set button 23 for a preselected period of time, e.g., 2 seconds or more in the stand-by of the apparatus. Then, a menu picture shown in FIG. 15a appears on the display 8 (step S621). When the user watching the picture of FIG. 15a selects “Substitute Message Information Setting” on the scroll button 21 or 22 (step S622), a menu picture shown in FIG. 15b appears on the display 8. When the user watching the menu picture of FIG. 15b presses the set button 23, a stored message data picture shown in FIG. 15c appears in place of the picture of FIG. 15b. Every time the user presses the scroll button 21 or 22, message data stored in the message storage 7 are sequentially read (step S601) while being sequentially displayed on the display 8 (step S602). The user determines whether or not the message data appearing on the display 8 includes a desired character or a desired character sequence (step S603). If the answer of the step S603 is NO, then another message data stored in the message storage 7 is read (step S601). If the answer of the step S603 is YES, then the user selects a desired part of the message data (step S604).

As shown in FIG. 15d, in the step S604, the user selects a desired start character on the scroll button 21 or 22 and then presses the set button 23 in order to enter the start character. Subsequently, as shown in FIG. 15e, the user selects a desired end character on the scroll button 21 or 22 and then presses the set button 23 in order to enter the end character. As shown in FIG. 15f, the user entered the end character selects “YES” indicative of the end of the setting of an original message on the scroll button 21 or 22 and then presses the set button 23. In response, the program ends the original message setting procedure (YES, step S605). Thereafter, the original message selected by the user is written to the replacement message information storage 5 (step S606). If the answer of the step S605 is NO, then another desired part to be replaced is selected (step S604).

After the above setting of the original message, a substitute message is set. Steps S608-S613 for setting a substitute message are identical with the steps for setting the original message and will not be described specifically in order to avoid redundancy. In a condition shown in FIG. 15h, the user selects a start character of message data stored on the message storage 7 on the scroll button 21 or 22 and then presses the set button 23 in order to enter to the start character. In a condition shown in FIG. 15i, the user selects an end character on the scroll button 21 or 22 and then presses the set button 23 in order to enter the end character.

After the substitute message has been set (step S613), the original message and substitute message are stored in the replacement message information storage 5 (step S614) in a pair. This is the end of the substitute message information setting procedure.

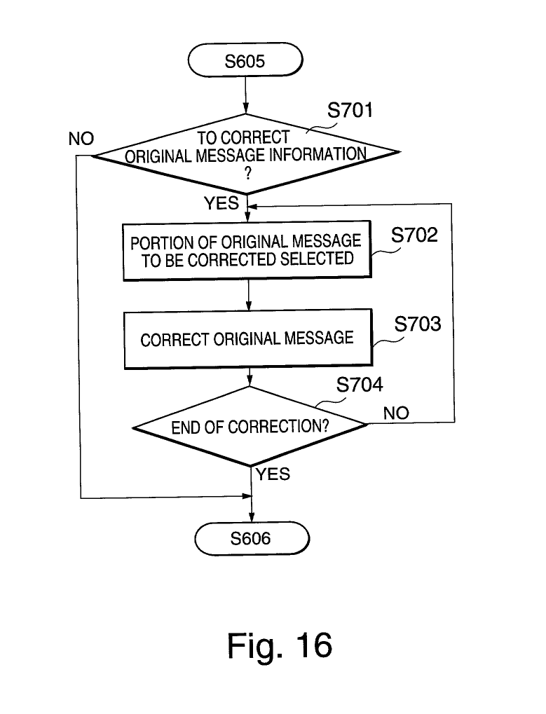

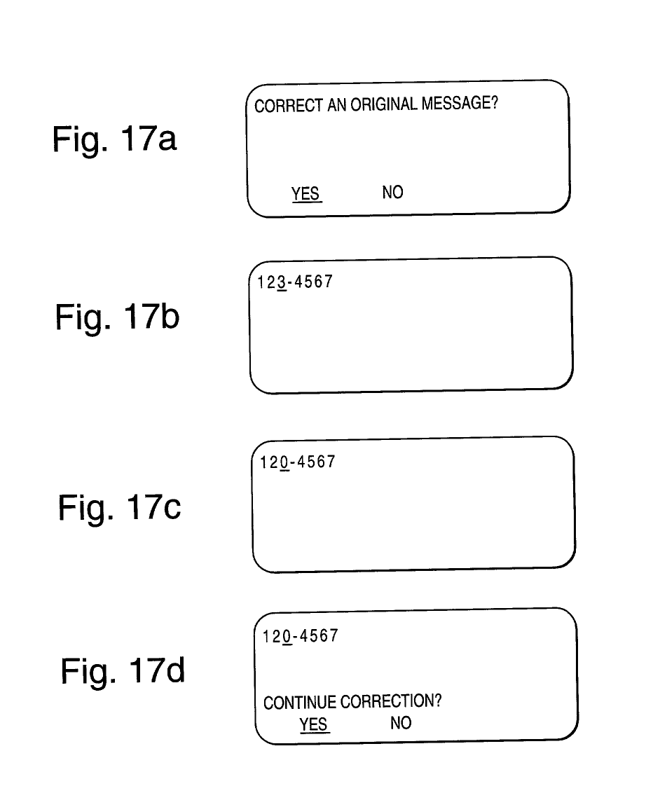

In the illustrative embodiment, the user once selected and entered an original message may correct a part of the message, as will be described with reference to FIG. 16. As shown, when the user enters an original message (S605, FIG. 14), a picture shown in FIG. 17a appears for urging the user to decide whether or not to correct the message (step S701). If the user selects “NO” on the scroll button 21 or 22 and then presses the set button 23 (NO, step S701), then the step S606 and successive steps shown in FIG. 14 are executed.

If the user selects “YES” on the scroll button 21 or 22 and then presses the set button 23 (YES, step S701), then a picture shown in FIG. 17b appears for urging the user to select a portion of the original message to correct. The user watching the picture of FIG. 17b selects a desired portion on the scroll button 21 or 22 and then presses the set button 23. In response, the initial value of the character, e.g., the letter “ [symbol] (A)” stored in the character font storage 6 appears. As shown in FIG. 17c, the user presses the scroll button 21 or 22 until a desired character appears. When the user finds a desired character and presses the set button 23, the original message is corrected (step S703). On the correction of the original message, a picture shown in FIG. 17d appears for urging the user to decide whether or not to end the correction procedure. If the user selects “NO” on the scroll button 21 or 22 and then presses the set button 23 (NO, step S704), then the picture of FIG. 17b again appears. The above procedure is repeated until the user selects “YES” of the picture shown in FIG. 17d on the scroll button 21 or 22 and then presses the set button 23 (YES, step S704).

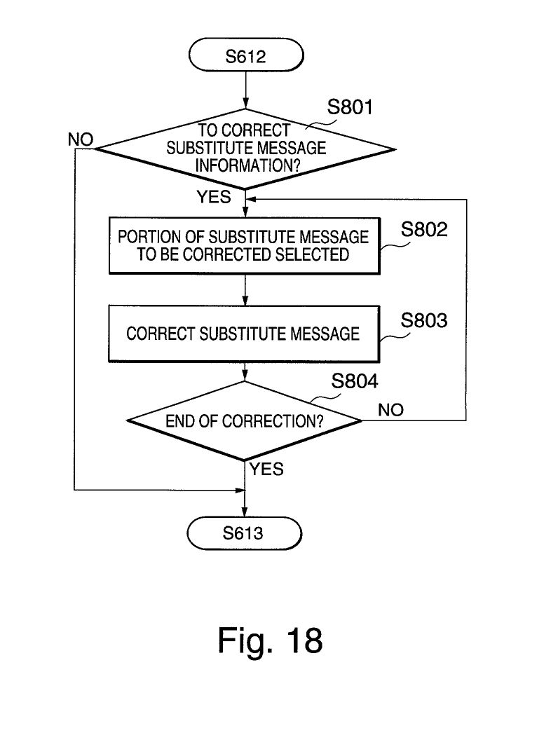

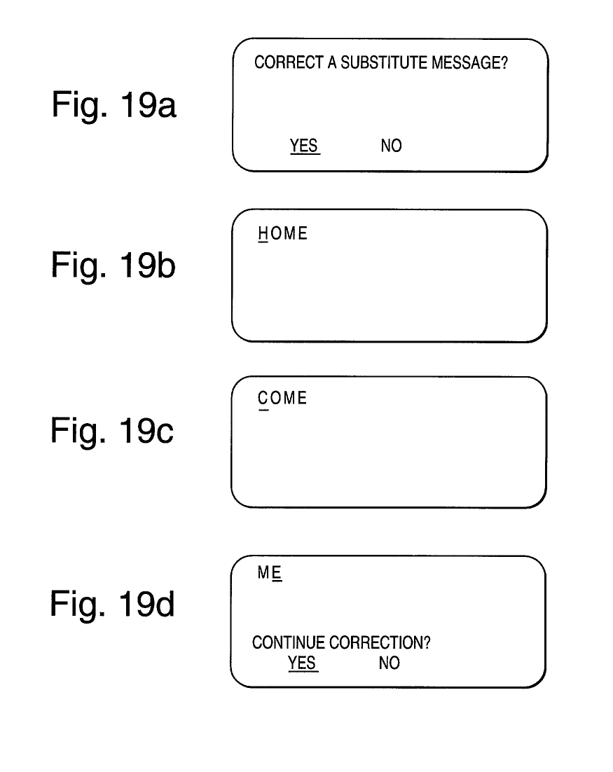

In the illustrative embodiment, the user once selected and entered a substitute message may also correct a part of the substitute message, as will be described with reference to FIG. 18. As shown, when the user enters a substitute message (S612, FIG. 14), a picture shown in FIG. 19a appears for urging the user to decide whether or not to correct the substitute message (step S801). If the user selects “NO” on the scroll button 21 or 22 and then presses the set button 23 (NO, step S801), then the step S613 and successive steps shown in FIG. 14 are executed.

If the user selects “YES” on the scroll button 21 or 22 and then presses the set button 23 (YES, step S801), then a picture shown in FIG. 19b appears for urging the user to select a portion of the substitute message to correct. The user watching the picture of FIG. 19b selects a desired portion on the scroll button 21 or 22 and then presses the set button 23. In response, the initial value of the character, e.g., the letter “ [symbol] (A)” stored in the character font storage 6 appears. As shown in FIG. 19c, the user presses the scroll button 21 or 22 until a desired character appears. When the user finds a desired character and presses the set button 23, the substitute message is corrected (step S803). On the correction of the substitute message, a picture shown in FIG. 19d appears for urging the user to decide whether or not to end the correction procedure. If the user selects “NO” on the scroll button 21 or 22 and then presses the set button 23 (NO, step S804), the picture of FIG. 19b again appears. The above procedure is repeated until the user selects “YES” of the picture shown in FIG. 19d on the scroll button 21 or 22 and then presses the set button 23 (YES, step S804).

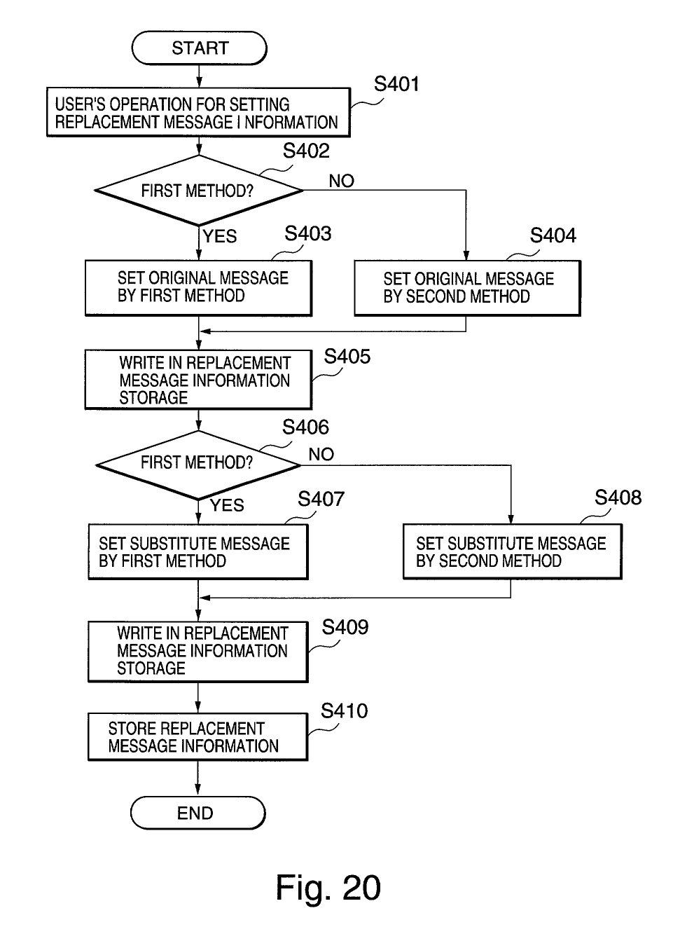

When the user is to set a desired original message and a substitute message, the user should preferably be capable of selecting and setting such messages on a character basis (FIGS. 12 and 13; a first method hereinafter) or on a start-and-end character basis (FIGS. 14 and 15; a second method hereinafter), as desired. This will be described with reference to FIGS. 20. As shown, the user sets substitute message information (step S401) The step S401 is identical with the steps S515 and 516 of FIG. 12 or the steps S621 and 622 of FIG. 14 and will not described in order to avoid redundancy.

After the step S401, whether or not the user has selected the first method is determined (step S402). If the answer of the step S402 is YES, an original message is set by the first method (step S403). The step S403 is identical with the steps S501-S506 of FIG. 12 and will not be described specifically. If the answer of the step S402 is NO, meaning that the user has selected the second method, then the original message is set by the second method (step S404). The step S404 is identical with the steps S601-S606 of FIG. 14 and will not be described specifically. The original message set is written to the replacement message information storage 5.

The above setting of the original message is followed by the setting of a substitute message. First, whether or not the user has selected the first method is determined (step S406). If the answer of the step S406 is YES, a substitute message is set by the first method (step S407). The step S407 is identical with the steps S507-S513 of FIG. 12 and will not be described specifically. If the answer of the step S406 is NO, meaning that the user has selected the second method, then the substitute message is set by the second method (step S408). The step S408 is identical with the steps S608-S613 of FIG. 14 and will not be described specifically. The substitute message set is written to the replacement message information storage 5. Thereafter, the original message and substitute message stored in the storage 5 in a pair (S410).

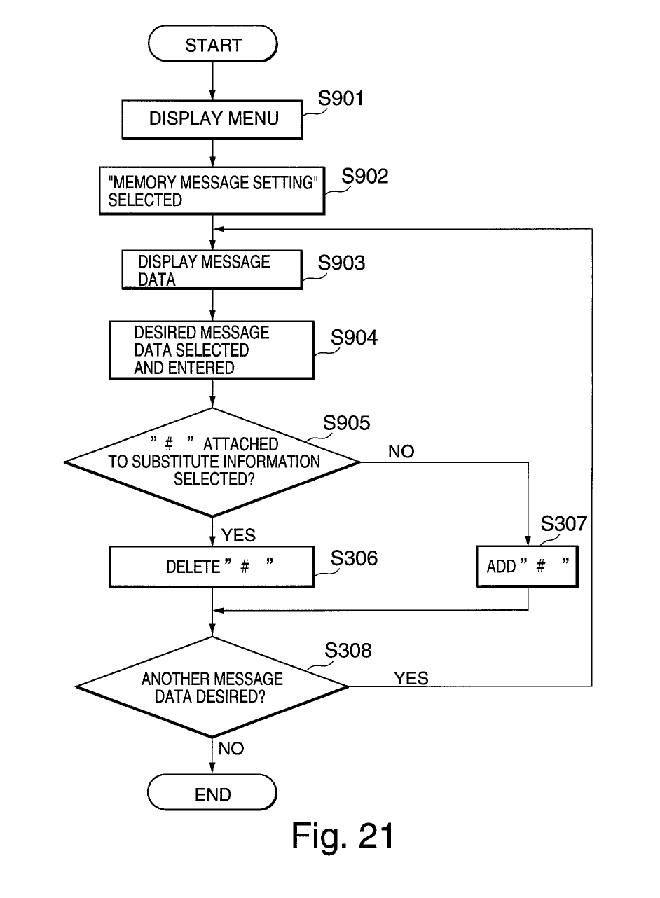

As shown in FIGS. 9 and 10, the user can set the substitute information stored in the storage 5 as substitute information to be substituted and can change the substitute information to be substituted to substitute information not to be substituted. Alternatively, the user is capable of setting the message data stored in the message storage 7 as a message not to be replaced, as will be described with reference to FIG. 21.

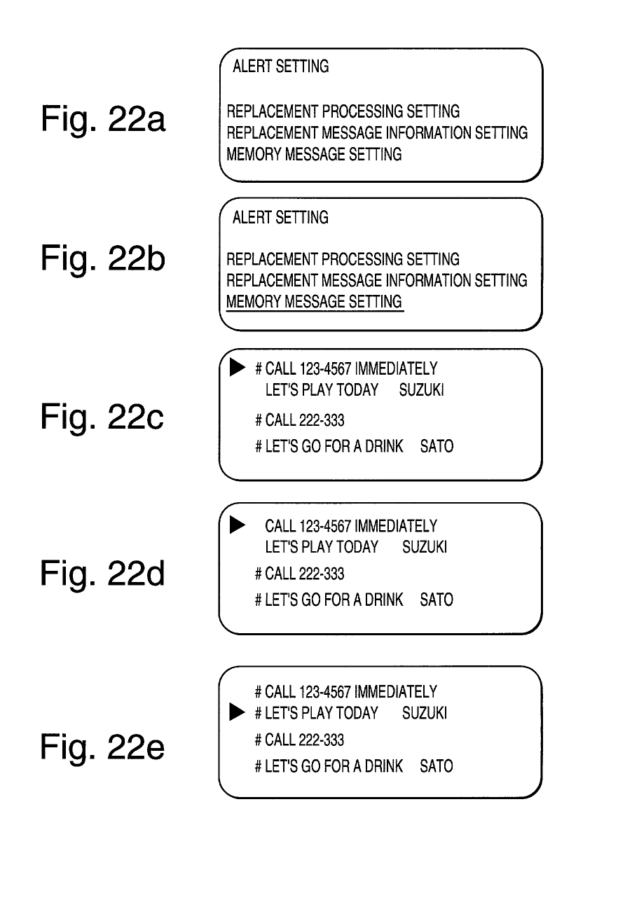

As shown in FIG. 21, when the user presses the set button 23 for a preselected period of time, e.g., 2 seconds or more in the stand-by of the pager, a menu picture shown in FIG. 22a appears (step S901). When the user selects “Memory Message Setting” on the scroll button 21 or 22 (step S902), a menu picture shown in FIG. 22b appears. When the user watching the picture of FIG. 22b presses the set button 23, message data stored in the message storage 7 appear, as shown in FIG. 22c (step S903). In FIG. 22c, the symbol “#” preceding any message data shows that the message data has been replaced with corresponding substitute information. That is, message data without the symbol “#” is not replaced with substitute information. The user watching the picture of FIG. 22c presses the scroll button 21 or 22 in order to select desired message data and then presses the set button 23 (step S904). Then, whether or not the symbol “#” is attached to the entered message data is determined (step S905). If the answer of the step S905 is YES, then the symbol “#” is deleted in order to prevent the message data from being replaced with the substitute information (step S906). If the answer of the step S905 is NO, then the symbol “#” is attached in order to replace the message data with the substitute information (step S907). After the decision on whether or not to replace the message data, whether or not any other message data to be set is present is determined (step S908). If the user desires to repeat the above replacement (YES, step S908), then the user selects another message data on the scroll button 21 or 22. This is followed by the steps S903-S907. FIG. 22d shows a preferred picture showing that the user has selected and entered, among the message data shown in FIG. 22c, message data “Call 123-4567 immediately.” as a message not to be replaced. Likewise, FIG. 22e shows a preferred condition wherein message data “Let's play today.” is selected as message data to be replaced.

In the illustrative embodiment, received message data are immediately written to the message storage 7. Alternatively, an arrangement may be made such that if the received message data include an original message stored in the replacement message information storage 5, the former is replaced with the latter and then written to the message storage 7. In such an alternative case, all the message data stored in the message storage 7 will appear on the display 8 in the form of messages replaced with substitute messages. This further enhances security of communication.

Further, the illustrative embodiment includes means for allowing the user to decide whether or not to substitute substitute information stored in the replacing message information storage 5. However, the user can delete substitute information stored in the storage 5 in the same manner as the user deletes received message stored in the message storage 7.

While the illustrative embodiment has concentrated on a radio pager, the present invention is, of course, applicable to a handy phone or a mobile data terminal by way of example.

In summary, it will be seen that the present invention provides a radio communication apparatus allowing the user of the apparatus to substitute desired contents for, e.g., telephone numbers and names which are included in messages received and stored, but should be kept from the third party. This not only enhances security of communication, but also improves reliability as to the personal use of the apparatus. In addition, the apparatus of the present invention is convenient to use and suitable for a broad range of applications because the user can set substitute message information by using characters stored in the apparatus or received messages already stored in the apparatus.

Obviously, numerous additional modifications and variations of the present invention are possible in light of the above teachings. It is therefore to be understood that within the scope of the present claims, the invention may be practiced otherwise than as specifically described herein.

What is claimed is:

1. A radio communication apparatus comprising:
first storing means storing an original message beforehand;
receiving means for receiving message data;
decision means for determining whether or not the message data includes the original message;
replacing means for replacing, when the message data includes the original message, said message data with another message data different from said message data; and
display means for displaying a substitute message output from said replacing means.

2. An apparatus as claimed in claim 1, wherein said first storing means stores the original message and the substitute message as a pair.

3. An apparatus as claimed in claim 2, wherein when said decision means determines that the message data includes the original message, said replacing means replaces a portion of the message data corresponding to the substitute message.

4. An apparatus as claimed in claim 2, wherein said first storing means stores a plurality of original messages and a plurality of substitute messages as pairs.

5. An apparatus as claimed in claim 4, further comprising setting means for allowing a user of said apparatus to decide whether or not to replace, among the plurality of original messages and the plurality of subsitute messages stored in said first storing means, said original messages with the substitute messages one by one.

6. An apparatus as claimed in claim 4, further comprising setting means for allowing a user of said apparatus to set the original messages and the substitute messages.

7. An apparatus as claimed in claim 6, wherein said setting means allows the user to set the original messages and the substitute messages by using at last one preselected character.

8. An apparatus as claimed in claim 7, further comprising second storing means for storing the message data received via said receiving means, wherein said setting mans allows the user to set the original messages and the substitute messages by using the message data stored in said second storing means.

9. An apparatus as claimed in claim 8, wherein said setting means comprises first setting means using a plurality of preselected characters and second setting means using the message data stored in said second storing means, said apparatus further comprising selecting means for allowing the user to select at least one of said first setting means and said second setting means.

10. An apparatus as claimed in claim 8, further comprising correcting means for allowing the user to correct the original messages and the substitute messages by using the message data stored in said second storing means.

11. An apparatus as claimed in claim 6, wherein said correcting means allows the user to correct the original messages and the substitute messages by using a plurality of preselected characters.

12. An apparatus as claimed in claim 4, further comprising deleting means for allowing the user to delete the original messages and the substitute messages stored in said first storing means.

13. An apparatus as claimed in claim 1, wherein said decision means including comparing means for comparing the message data and the original message data character by character, starting at a leading character.

14. An apparatus as claimed in claim 1, further comprising:
second storing means for storing message data received via said receiving means; and
reading means for reading the message data out of said second storing means.

15. An apparatus as claimed in claim 14, wherein said decision means determines, when said reading means reads the message data, whether or not said message data includes the original message.

16. An apparatus as claimed in claim 14, further comprising setting means for allowing a user of said apparatus to decide whether or not to replace the message data stored in said second storing means with the another message data.

17. An apparatus as claimed in claim 1, wherein said apparatus comprises a radio selective calling receiver.

18. A radio communication apparatus comprising:
a replacement message information storage storing original message beforehand;
a radio section for receiving message data;
a message processing section for determining whether or not the message data includes the original message and replacing, when said message data includes said original message, said message data with another message data different from said message data; and
a display for displaying a substitute message output from said message processing section.

19. A method of processing a message received by a radio communication apparatus, comprising the steps of:
receiving message data;
determining whether or not the message data includes an original message stored beforehand;
replacing, when the message data includes the original message, said message data with another message data different from said message data to thereby output a substitute message; and
displaying the substitute message.

20. A method as claimed in claim 19, further comprising the step of storing the original message and the substitute message as a pair.

21. A method as claimed in claim 20, wherein said replacing step comprises replacing a portion of the message data corresponding to the original message with the substitute message.

22. A method as claimed in claim 20, further comprising the steps of:
causing a user of the apparatus to select a desired replacement setting mode;
displaying replacement information;
causing the user to select desired replacement information out of the replacement information displayed; and
setting, as a message to be replaced with the substitute message, the original message based on the replacement information selected by the user.

23. A method as claimed in claim 22, further comprising the steps of:
determining whether or not the replacement information selected has already been selected; and
setting, if the replacement information selected has already been selected, the original message based on said replacement information as a message not to be replaced.

24. A method as claimed in claim 19, further comprising the steps of:
causing a user of the apparatus to select a replacement message information setting mode;
sequentially displaying a plurality of preselected characters;
causing the user to select desired characters;
setting at least one of the characters selected by the user as the original message;
sequentially displaying a plurality of preselected characters;
causing the user to selected desired characters; and
setting at least one of the characters selected by the user as the substitute message.

25. A method as claimed in claim 19, further comprising the steps of:
storing the message data received;
causing a user of the apparatus to select a replacement message information setting mode;
displaying the message data;
causing the user to select a desired portion of the message data displayed;
setting the desired portion of the message data as the original message;
displaying the message data;
causing the user to select another desired portion of the message data; and
setting the another desired portion of the message data as the substitute message.

26. A method as claimed in claim 25, further comprising the steps of:
causing the user to decide whether or not to correct the original message set in said setting step;
causing the user to select a portion of the original message to correct;
sequentially displaying a plurality of preselected characters;
causing the user to selected a desired one of the plurality of characters; and
correcting the portion selected by the user with the character selected.

27. A method as claimed in claim 25, further comprising the steps of:
causing the user to decide whether or not to correct the substitute message set in said setting step;
causing the user to select a portion of the substitute message to correct;
sequentially display a plurality of preselected characters;
causing the user to select a desired one of the plurality of characters; and
correcting the portion selected by the user with the character selected by the user.

28. A method as claimed in claim 19, further comprising the steps of:
storing the message data received;
causing a user of the apparatus to select a replacement message information setting mode;
causing the user to select either one of a first method for setting the original message and the substitute message by using a plurality of preselected characters and a second method for setting said original message and said substitute message by using the message data stored; and
setting the original message and the substitute message by using one of said first method and said second method selected by the user.

29. A method as claimed in claim 19, further comprising the steps of:
storing the message data received;
reading the message data stored;
determining whether or not the message data read includes the original message stored beforehand;
replacing, when the message data includes the original data, said message data with another message data different from said message data to thereby output a substitute message; and
displaying the substitute message.

30. A method as claimed in claim 29, further comprising the steps of:
causing the user to decide whether or not to replace the message data stored;
replacing the message data to be replaced, as decided by the user, with another message data different from said message data to thereby output a substitute message;
displaying the substitute message; and
displaying the message data not be to be replaced, as decided by the user, without replacing said message data.
